(19) United States
(12) Patent Application Publication
(10) Pub. No.: US 2010/0003099 A1
(43) Pub. Date: Jan. 7, 2010

(54) Corner Element

(76) Inventor: Hella-Heike Zimmermann, Potsdam (DE)

Correspondence Address: RICHARD M. GOLDBERG, 25 EAST SALEM STREET, SUITE 419, HACKENSACK, NJ, 07601, US

(21) Appl. No.: 12/373,779

(22) PCT Filed: Jul. 13, 2007
(86) PCT No.: PCT/EP07/06249

§ 371 Date: Jan. 14, 2009

(30) Foreign Application Priority Data
Jul. 14, 2006 (DE) 20 2006 010 937.4
Sep. 25, 2006 (DE) 20 2006 014 730.6

(51) Int. Cl. B61D 45/00; F16B 7/04; B65D 88/14; B23P 6/00

(52) U.S. Cl. 410/140; 403/171; 29/402.09

(57) ABSTRACT

Corner element for a framework construction for airfreight, for connecting two frame parts (1) that each includes a hollow space (2) to each other, in which the corner element includes a first corner part (4, 5) and a second corner part (6; 8), and in which the first corner part (4, 5) is arranged to be at least partially accommodated in the hollow space (2) of a first frame part (1), and in which the second corner element (6; 8) is arranged to be at least partially accommodated in the hollow space (2) of a second frame part (1); and framework construction having such a corner element, and method of re-manufacturing such a framework construction.

The invention relates to a corner element for a framework construction for airfreight for connecting two frame parts, which each comprise a hollow space. In particular, the corner element is adapted for connecting such frame parts, which frame parts are arranged such that their ends together form an angle, in particular an angle of 90°. Further, the invention relates to a frame-work construction for airfreight having such a corner element, and to a method for re-manufacturing such a framework construction.

For example, the framework construction is a component of a bottom board of a metal pallet or a container, such as they are primarily used in the aircraft industry. Metal pallets, containers and the like, which are employed in the aircraft industry, usually have at their bottom a framework construction of a shape that is standardized worldwide. The framework construction serves for fastening the pallets or containers to the air plane.

A known framework construction is constructed as follows: the lower boarder area of a pallet bottom or a container comprises an allround framework construction, which comprises several frame parts in the form of frame profiles, which have hollow spaces at their ends. For example, the frame parts are frame profiles, in particular hollow profiles. The ends of the frame parts are truncated and meet at the respective corners of the framework construction at respective connection positions, forming an angle of 90°. The framework construction is manufactured by using corner elements having two pins that form an angle of 90° with each other, onto which pins the respective frame profiles are pushed. A respective pin is inserted into the adjacent hollow space of the respective frame part. After connecting the frame parts adjoining each other through a corner element, the frame parts are riveted along their longitudinal sides to a bottom board of the pallet or of the container.

During the life time of a metal pallet or a container, it often happens that the corner elements of the framework construction are badly deformed such that they have to be exchanged, due to the rough handling of the framework construction and due to the heavy load of the freight. The conventional construction of the corner elements and the framework construction has the strong disadvantage, that, due to the angle of 90° between the adjoining frame parts, at least one frame piece has to be completely detached from the framework construction in order to exchange one corner element. For example, in case of the conventional rivet connection between the frame parts and the pallet bottom or the bottom board of a container, at least one frame part has to be completely detached from the bottom, when a corner element is to be exchanged. The complete detaching is necessary in order to be able to remove the pins of the corner elements from the hollow spaces of the frame parts, which are offset from each other by 90°, at a corner. After removing the damaged corner element, a new corner element is reintroduced with its pin into this corner element, and the frame part with the inserted corner elements is again attached to the counterparts of the framework construction, wherein the respective pins of the corner elements again enter the hollow spaces of the counterparts of the framework construction. Then, the frame part has to be riveted again. However, detaching and re-connecting the frame parts means a loss of quality, because the riveted joints get loose due to the inadvertable movement of the whole bottom board.

It is an object of the invention to provide a novel framework construction that avoids the above described disadvantages when exchanging a corner element.

In particular, it is an object of the invention to provide a framework construction that considerably simplifies the assembly processes, when a corner element is exchanged, and that, in particular, avoids the losses of quality that are associated with detaching the frame parts from the bottom.

In particular, the invention should allow a reuse of the already existing framework constructions and allow a simple conversion into a framework construction according to the invention.

According to the invention, this object is achieved by a corner element for a framework construction for airfreight, for connecting two frame parts with each other, which frame parts each comprise a hollow space, wherein the corner element comprises a first corner part and a second corner part, and wherein the first corner part is arranged to be accommodated in the hollow space of a first frame part, and wherein the second corner part is arranged to be accommodated in a hollow space of a second frame part. However, the corner parts do not necessarily have to be completely accommodated in the respective hollow space; nevertheless, they are each arranged to be at least partially accommodated, for example with a foot portion or a pin. The hollow spaces of the frame parts or frame profiles may be positioned at a specific angle to each other, for example 90°. Preferably, the corner element is arranged to connect the frame parts firmly but detachably. For example, the frame parts are frame legs of the framework construction. The respective hollow spaces or hollow chambers may, for example, be formed by a hollow frame profile, that is, a hollow profile. For example, the corner element is made from aluminium, plastics or materials equally useable for this purpose.

Because the corner element, according to the invention, is divided in at least a first corner part and a second corner part, which, or the pins of which, are accommodated by the first or the second frame part, respectively, it is made possible to exchange such a corner element at the framework construction without detaching, for example, the framework construction from the body of the bottom board or the container structure. Due to the construction of the corner element according to the invention, the frame parts to be connected may already be in their end position, when the corner element is inserted, because the corner parts may be designed to be insertable one by one, for example, one after each other, into the frame parts. In case of a damaged corner element, the corner element, which is detachably connected to the framework construction, may be removed by cutting it using a cutter, so that the resulting pieces may be-pulled out of the respective hollow spaces of the frame parts. The basic idea of the invention is to design the corner of a framework construction as an exchangeable part of this framework construction, which part may be exchanged without having to dismount the rest of the framework construction. Thereby, the disadvantages described above are avoided.

Useful details of the invention are indicated in the depended claims.

Preferably, the first corner part and/or the second corner part each comprise a portion or pin for inserting into the hollow space of the respective frame part, which portion or pin has a cross section that is substantially adapted to the cross section of the hollow space. Thereby, a good fit of the respective corner part in the hollow space is achieved. Said portion, which in the following is also referred to a foot, has, for example, dimensions and a cross section, which are identical or substantially identical to that of the hollow space of the respective frame part.

Preferably, the second corner part is attachable to the first corner part. By attaching the corner parts to each other, the stability of the corner element is enhanced.

In one embodiment, the first corner part and the second corner part are constructed to be wedgable to each other. Wedging is to be understood to include, in particular, jamming or chocking. By wedging the first corner part to the second corner part, a considerably firm and robust connection of the corner parts to each other is achievable.

In a preferred embodiment, an opening for accommodating the second corner part passes through the first corner part. Preferably, said opening passes through a head portion of the first corner part. In the following, the head portion is also referred to as a head. When the second corner part is accommodated in the opening in the first corner part, the second corner part may be connected to the first corner part in a manner that is particularly dimensionally stable. Preferably, the opening has the size of a head part or head portion of the second corner part. Preferably, the shape of the opening is adapted to the shape of a head portion of the second corner part or vice versa.

Preferably, in a position for use of the corner element, that part of the second corner part, which is fixed in the opening, that is, the head portion, has a cross section that is identical to that of the hollow space.

Preferably, the second corner part is inserted into the hollow space of the frame profile through the opening of the first corner part and firmly wedges these corner parts to the frame parts.

Preferably, the second corner part is, when the first corner part is inserted into the first frame part up to a specific position, slidable into a position, in which it is accommodated in the opening of the first corner part and the hollow space of the second frame part. Thus, in this position, the second corner part forms the connection between the first corner part and the second frame part. Said positions of the corner parts form the position for use of the corner elements. Said slidability of the second corner part is achievable in different ways by suitable shaping the corner parts. A first possibility is, that, when mounting the corner elements, first, the second corner part is inserted into the hollow space of the second frame part, until the first corner part is insertable, for example, past the second corner part into the first frame part up to the specific position. Then, after inserting the first corner part, a head portion of the second corner part is pulled through the opening into the opening of the first corner part. A second possibility is, that, first, the first corner part is pushed into the first frame part up to the specific position, and then the second corner part is pushed from outside first into the opening and then further into the second frame part. Depending on the shape of the corner parts, the second corner part may be slided into its end position either out of the hollow space of the second frame part, or in the opposite direction. For example, the first possibility is given when the second corner part has a cross section that corresponds to the cross section of the hollow space of the respective frame part. Thereby, during the assembly, the second corner part may be introduced into the hollow space of the frame profile such far that even the front face of this corner part is fully inserted behind the edge of the frame part. This allows then to insert the first corner part into the other frame part, which is arranged at an angle of 900 with respect to the first frame part.

In one embodiment, the opening of the first corner part widens to the outer side of the corner element, and the second corner part comprises a head portion adapted to the shape of the opening. Preferably, the head portion is such adapted to the shape of the opening, that the second corner part is wedgable to the first corner part by inserting it into the opening. In particular, when the first corner part is inserted up to a specific position into the first frame part, the second corner part is insertable into the opening and into the second frame part into a position, in which it is accommodated in the opening of the first corner part and in the second frame part and is wedged to the first corner part. This structure results in a particular simple and sure mounting of the corner element.

Preferably, the opening widens in the shape of a truncated pyramid, that is, conically in the meaning of a cone having, for example, a rectangular cross section. Such a uniform widening particularly facilitates wedging or jamming the second corner part in the opening. Preferably, the larger open end of the opening is arranged at the opposite side of the frame profile.

Preferably, the first corner part is formed in one piece. The second corner part is preferably formed in one or more pieces. More preferably, the second corner part is formed in one or two pieces. Further, preferably, the corner element consists of the one-piece first corner part and the one-piece or two-piece second corner part.

In one embodiment, the second corner part is formed in two pieces. Preferably, it is divided along its longitudinal direction. A firm connection, for example, between the first corner part and the second corner part, is achievable by changing the position of the parts of the second corner part relative to each other, for example by jamming or wedging the second corner part to the first corner part.

Preferably, the side walls of the two-piece second corner part do not form a right angle with each other. Thus, the second corner part has a none-rectangular cross section. Such a structure particularly facilitates jamming or wedging or pressing the parts of the second corner part to, for example, the first corner part.

Preferably, the two-piece second corner part comprises side walls such that it is insertable into the hollow space of the second frame part in a position, in which these side walls do not form a right angle with the walls of the hollow space. Such a shape of the second corner part particularly facilitates attaching the second corner part to the walls of the hollow space by jamming or wedging.

Preferably, the corner element comprises a threaded joint, by means of which the second corner part is wedgable to the first corner part and/or in the hollow space of the second frame part. For example, the second corner part is wedgable in the opening of the first corner part. When the wedging is effected by means of a threaded joint, a particularly high contact pressure may be created.

Preferably, the second corner part is formed in two pieces such that screwing the threaded joint causes an expanding of the two-part corner part. In this manner, a particulary good wedgibility of the second corner part is achievable.

Furthermore, the object is achieved by a framework construction for airfreight, comprising at least a first and a second frame part, each of which comprise a hollow space, wherein the ends of the frame parts form an angle at a corner of the framework construction, and wherein the framework construction comprises a corner element of the kind described above, which connects the frame parts at the corner. Such a framework construction may, for example, be created by exchanging the conventional corner element of a conventional framework construction by a corner element according to the invention.

In one embodiment, at least one of the frame parts comprises a threaded joint for attaching the corner element. Such a threaded joint may, for example, be additionally worked into an existing, conventional framework construction. For example, the framework construction comprises a threaded joint, by means of which the second corner part is wedgable in the hollow space of a second frame part.

Furthermore, the object is achieved by a method of re-manufacturing a framework construction of the kind described above, which method comprises the steps of:
inserting the first corner part into the hollow space of the first frame part;
inserting the second corner part into the hollow space of the second frame part.

An optional step of the method is: attaching the first and second corner parts to each other. Preferably, the steps of inserting are performed without detaching the respective frame parts from the framework construction.

In particular, the method of re-manufacturing a framework construction may be a part of a method for exchanging a corner element of the framework construction. In particular, it may comprise the step of: removing a corner element to be exchanged, involving destroying said corner element. For example, a damaged corner element may be cut using a parting-off grinder, and the components may be removed, before the corner parts according to the invention are inserted into the uncovered hollow spaces of the frame parts. Again, preferably, the steps of removing the corner elements to be exchanged, and of inserting the corner elements, are performed without detaching the frame parts from the framework construction.

The method according to the invention is in particular advantageous in that the stability of the framework construction is not harmed by detaching rivet joints of the frame parts. Furthermore, considerable time is saved. It is also advantageous that the method according to the invention, in which method the corner element according to the invention is employed, is also applicable for repairing a conventional framework construction having a conventional, damaged element. The conventional corner element is exchanged by the corner element according to the invention without requiring a detaching of frame parts from the framework construction.

In the following, preferred embodiments of the invention are explained with reference to the drawings.

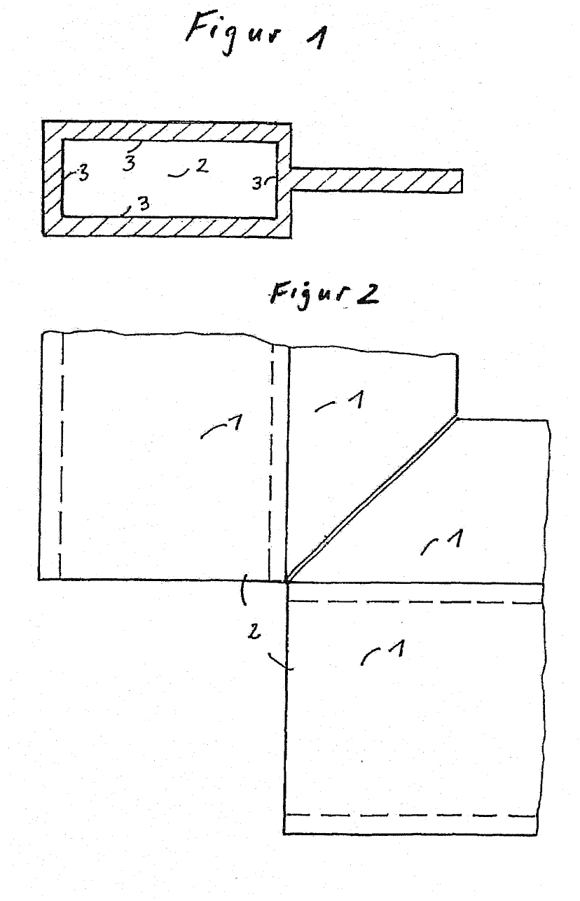

FIG. 1 shows a cross-section of a frame profile;

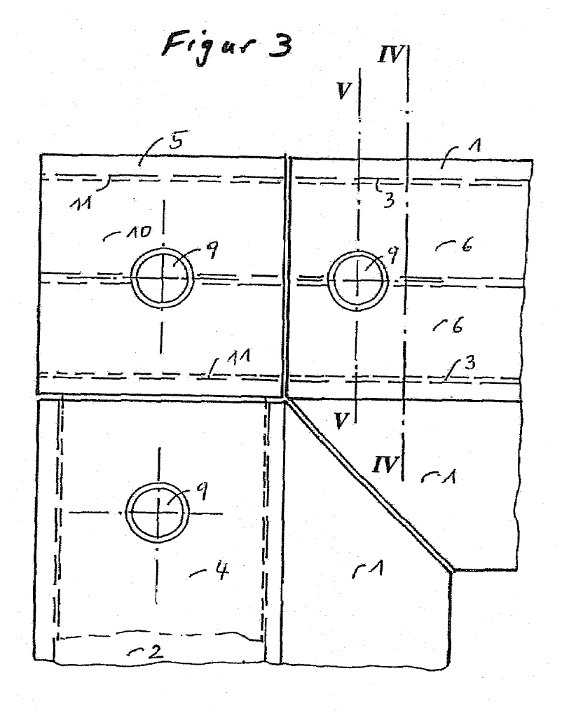

FIG. 2 shows a top view of a part of a framework construction having two frame profiles that adjoin each other at an angle of 90°, without a corner element;

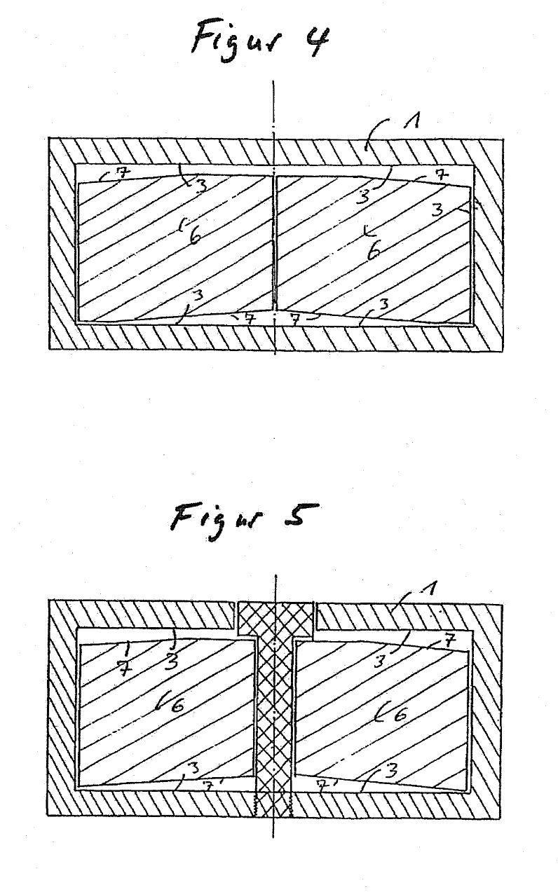

FIG. 3 shows a top view of a corner connection of the framework construction, with a corner element having a first and a second corner part with threaded joints;

FIG. 4 shows a cross-section of a frame part and the inserted two-piece second corner part along the line IV-IV of FIG. 3;

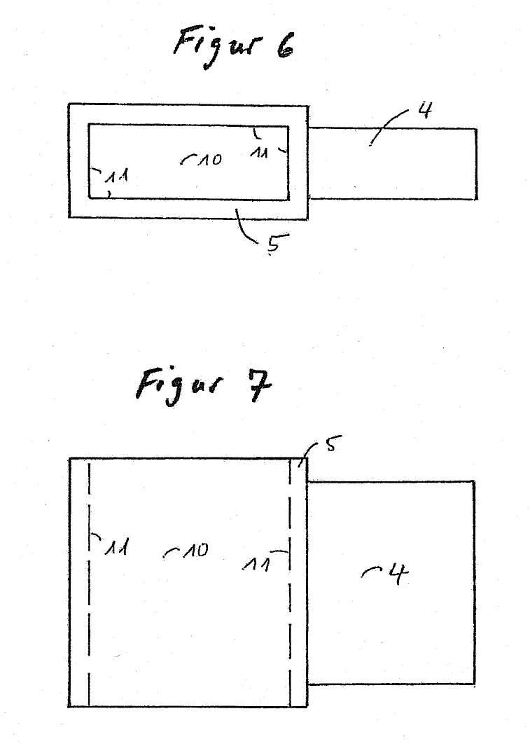

FIG. 5 shows a sectional view of the frame part and the inserted two-piece second corner part and a threaded joint along the line V-V of FIG. 3;

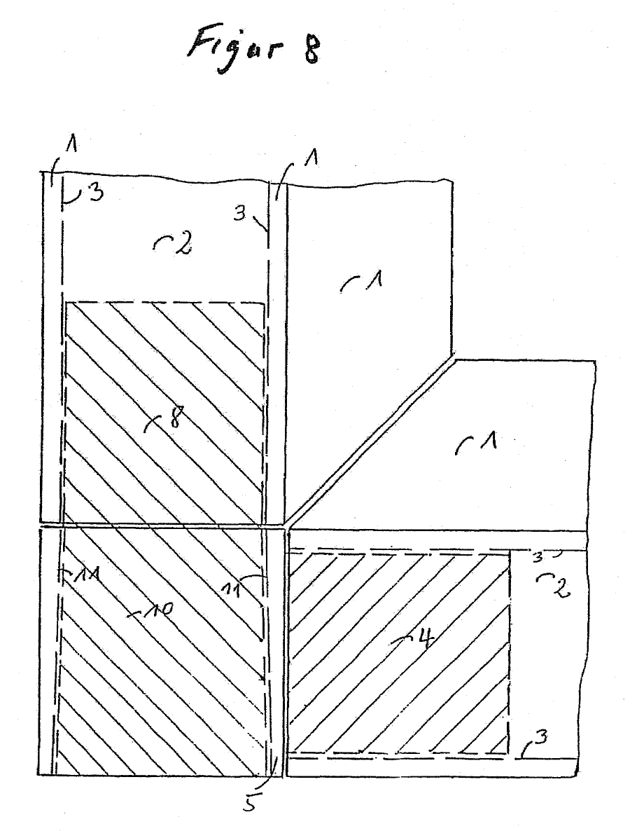

FIG. 6 shows a side view of the first corner part having a head portion and a pin;

FIG. 7 shows a top view of the first corner part of FIG. 6;

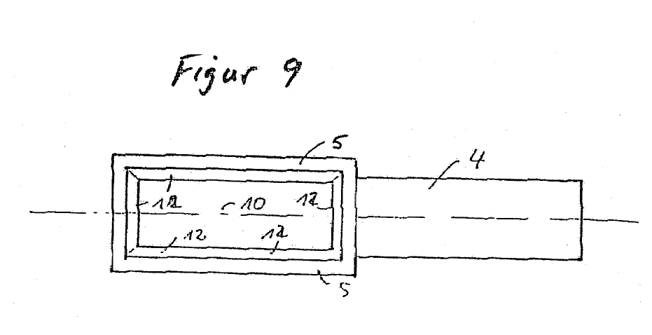

FIG. 8 shows a top view of a corner connection of two frame parts of a framework construction with a corner element according to a further embodiment, having a one-piece second corner part, which is inserted through the head portion of a first corner part;

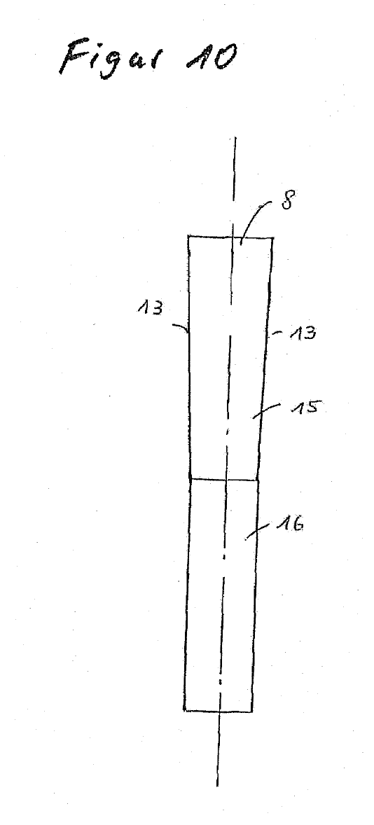

FIG. 9 shows a side view of the first corner part of FIG. 8, having an opening in the head portion; and

FIG. 10 shows a view of one-part second corner part of FIG. 8.

FIG. 1 schematically shows a cross-section of a frame part 1 in the form of a frame profile. A hollow space 2 is delimited by inner side walls 3 of the frame part 1.

FIG. 2 shows two frame parts 1 of that kind at a corner of a framework construction. The areas of the frame parts 1 surrounding the hollow space 2 are truncated at their ends, that is, cut an angle of 90° to their longitudinal direction. The frame parts 1 are assembled to form a frame under an angle of, for example, 90°. At the abutting ends, the end faces, at which the hollow spaces 2 end, are positioned at an angle of 90° and adjacent to each other. This structure of the framework construction corresponds to a conventional framework construction.

A firm connection between the frame parts at the abutting ends, according to a first embodiment to the invention, is described in the following with reference to FIGS. 3 to 7. According to this embodiment, a corner element is employed, which consists of a one-piece first corner part (FIGS. 6 and 7) and a two-piece second corner part. The one-piece, first corner part comprises a foot portion or pin 4 and a head or head portion 5. The second, two-piece second corner part 6 is cut through its center by a substantially vertical cut along a longitudinal direction, as it is shown in FIG. 4.

The cross section of the pin 4 of the one-piece corner part corresponds to the cross section of the hollow space 2 of the lower frame part of FIG. 3 and is insertable into this frame part. An opening 10 passes through the head portion, the head portion being that part of the first corner part that projects from the hollow space 2. The size of the opening 10 corresponds to the size of a head portion of the two-piece corner part 6. In the described example, the cross section of the head portion is uniform with the cross section of the foot portion of the corner piece 6, which is inserted into the frame part 1 in FIG. 3.

For assembling, first, the two-piece second corner part 6 is inserted into the hollow space 2 of the second frame part 1, which is on the right side in FIG. 3, until its front face is in line with the outer edge of the hollow space 2. Then, the one-piece, first corner part is inserted into the first frame part, which is the lower frame part in FIG. 3, until the end faces of an opening 10 in the head portion 5 of the one-piece corner part are in line with the end face of the hollow space of the other frame part. Thereby, inner side walls 11 of the head portion 5, which delimit the opening 10, are aligned to the inner side walls 3 of the opposing hollow space of that frame part 1, which is on the right side in FIG. 3.

Then, the two-piece corner part 6 is pulled outwards out of the hollow space 2 through the opening 10 of the one-piece first corner part, until its front face is in line with the outer edge of the one-piece first corner part. In this position, which is shown in FIG. 3, the corner parts are firmly connected to each other by introducing several special purpose screws. One such threaded joint 9 is exemparily shown in FIG. 5.

As is shown in FIGS. 4 and 5, the two-piece second corner part 6 has side faces 7 at its side walls, which do not form a right angle with each other. The side faces form angles of different degrees with each other. The inner side walls 3 of the hollow space 2 have different angles than those of the corner part 6. The faces of the outer sides of the two-piece corner part 6 are sloped by some degrees with respect to the faces of the inner side walls 3 of the hollow space 2 of the frame part 1. The same applies for the parting lines of the two components of the corner part 6 with respect to each other. Thus, the hollow space comprises different angled faces with respect to the corner part.

The outer edges have such an extension that they fit into the hollow space 2. When the two-piece corner part 6 is inserted, its neighbouring inner faces lie against each other. On inserting, the outer edges contact the inner walls 3 of the hollow space 2. By tightening the screws of the threaded joints 9, the parts of the two-piece corner part 6 are expanded and jammed or wedged to the side walls 3 of the hollow space 2 as well as to the side walls 11 of the opening 10. Thereby, a firm connection is established, which, however, may also be detached if required, for example in order to exchange the corner element.

Thus, the shown corner element consists of the one-piece corner part and the two-piece corner part 6. The opening 10 in the one-piece corner part serves for accommodating the second corner part 6.

Alternatively to providing the central parting line of the two-piece corner part 6, the parting line may also be offset. When the parting line of the two-piece corner part 6 is offset, the parts of the two-piece corner part may comprise the same or different cross sectional sizes.

On manufacturing the two-piece corner part 6, or previously to the assembly, the drilling hole for the threaded joint 9 is manufactured as follows. Both parts of the two-piece corner part are layd with their upper and lower surfaces straighty onto a support, and a hole for the threaded joint is provided at, for example, two positions. The drilling hole or the drilling holes are introduced such that, during the drilling process, the two parts of the corner part are layd onto the ground with parallel base surfaces in the pre-fabrication. In doing so, the opposing surfaces are not parallel to each other, but form a wedge that opens downwards. In this position, a drilling hole is drilled centrally through the parting line. When, during assembly of the framework construction, these two parts of the corner part 6 are inserted into the hollow space 2, the drill hole assumes an approximately conical shape. In order to create the threaded joint 9, a screw is inserted through a hole in the frame part 1 and is inserted into a thread in the lower wall of the frame part. In doing so, the screw head presses onto the two-piece corner part 6. Now, by means of this screw, the two-piece corner part 6 may be expanded and, thus, be pressed against the hollow space 2 of the frame part and be attached thereto. For example, the threaded joint connecting the two-piece corner part 6 to the head portion 5 of the one-piece corner part is implemented in the same manner. The screw may be a special purpose screw having a conical shank. By creating the threaded joint or threaded joints, a jamming connection of the frame parts 1 to the corner parts is provided.

Due to the expanding of the two-piece part, its edges are pressed against the hollow space 2 of the frame art 1, so that the two-piece corner part is wedged. The same happens in the head portion 5, in which now both corner parts are brought together. Because of the threaded joints, the two corner parts are wedged and form a firm connection of the two frame parts 1 and the corner element.

In a further embodiment of the invention, the second corner part is formed in one piece. In the example, which is shown in FIGS. 9 and 10, the opening 10 that passes through the head portion 5 of the first corner part widens towards the front face in the shape of a truncated pyramid, in being delimited by side faces 12 that are inclined towards each other (FIG. 9).

The one-piece second corner part 8 has a head portion 15 having side faces 13, which are inclined towards each other and which are adapted to the shape of the opening 10. The dimensions and the cross section of a foot portion 16 of the one-piece second corner part 8 correspond to the cross section of the hollow space 2 of the frame profile 1. The head portion has dimensions and a cross section that are identical to that of the hollow space of the opening 10 of the head portion 5 of the first corner part. In the following, this first corner part is also refered to as the head corner part. The foot portion 16 and the hollow space 2 of the respective frame part 1 have parallel surfaces all over.

In the shown embodiment, the larger cross section of the conically widening head portion 15 and of the opening 10, which widens in a similar manner, is arranged at the outer side of the corner element, that is, at the side opposite to the foot portion 16.

The assembly is carried out as described in the following. A second corner part, which comprises the opening 10, is inserted into the respected frame part. Then, the one-piece second corner part 8 is inserted through the hollow space of the opening 10 in the head portion 5 of the first corner part and is inserted with the foot portion 16 into the other frame part. In the position for use, the head portion 15 of the second head corner part 8 is wedged inside the hollow space of the opening 10 of the head corner part. A firm connection between the frame parts and the corner parts is created.

Optionally, a threaded joint may be provided through the head portion 5 for securing this connection, or a welded joint may be provided at the outer side, through which the one-piece corner part 8 was inserted.

In a third embodiment, the cross section of the one-piece second corner part corresponds to the cross section of the hollow space of the frame parts, and by means of one ore more screws through the head portion 5 of the first corner part and/or through the frame parts 1, a firm connection is provided. For example, the opening 10 may then correspond to the embodiment shown in FIG. 6.

For example, the second corner part may comprise a slit. This facilitates an accurately fitting accommodation of the corner part in the respective hollow space. For example, the slit is arranged in a region which is to be inserted into the hollow space, this region being the foot portion of the corner part. Preferably, the foot range is divided by the slit into two tongues. Thereby, a certain resilience in the cross direction, that is, transverse to the slit, is effected. Preferably, the slit extends in the longitudinal direction of the corner part.

The corner element according to the invention and the framework construction according to the invention considerably reduce the mounting costs for exchanging damaged corners. The separate frame parts of a bottom or a container do not have to be detached anymore, but only the corner element to be exchanged is detached and replaced as described above. Thereby, the assembly time may be reduced by 90%, and the costs of material may also be reduced by, for example, up to 80%.

What is claimed is:

1. Corner element for a framework construction for airfreight, for connecting two frame parts that each comprise a hollow space to each other, comprising:
a first corner part arranged to be at least partially accommodated in the hollow space of a first frame part, and
a second corner part is arranged to be at least partially accommodated in the hollow space of a second frame part.

2. Corner element according to claim 1, wherein at least one of the first corner part and the second corner part comprise a portion for inserting into the hollow space of the respective frame part, which portion comprises a cross section that is substantially adapted to the cross section of the hollow space.

3. Corner element according to claim 1, wherein the second corner part is attachable to the first corner part.

4. Corner element according to claim 1, wherein the first corner part and the second corner part are constructed such that they are wedgable to each other.

5. Corner element according to claim 1, wherein a head portion of the first corner part includes an opening for accommodating the second corner part.

6. Corner element according to claim 5, wherein, when the first corner part is introduced into the first frame part up to a specific position, the second corner part is slidable into a position, in which it is accommodated in the opening of the first corner part and in the hollow space of the second frame part.

7. Corner element according to claim 5, wherein:
the opening of the first corner part widens towards an outer side of the corner element, and
the second corner part comprises a head portion, which is adapted to the shape of the opening such that the second corner part is wedgable to the first corner part by inserting it into the opening.

8. Corner element according to claim 5, wherein the opening widens in the shape of truncated pyramid.

9. Corner element according to claim 1, wherein the second corner part is formed in two pieces.

10. Corner element according to claim 9, wherein side walls of the two-piece second corner part do not form a right angle with each other.

11. Corner element according to claim 9, wherein the second corner part comprises side faces such that it is insertable into the hollow space of the second frame part in a position, in which these side faces do not form a right angle with walls of the hollow space.

12. Corner element according to claim 1, wherein the corner element comprises a threaded joint, by which the second corner part is wedgable at least one of the following:
to the first corner part and
in the hollow space of the second frame part.

13. Corner element according to claim 12, wherein the second corner part is formed in two pieces such that a tightening of the threaded joint effects an expanding of the two-piece corner part.

14. Framework construction for airfreight, comprising:
at least a first and a second frame part, each of which comprise a hollow space, wherein ends of the frame parts form an angle at a corner of the framework construction, and
a corner element which connects the frame parts at said corner, said corner element comprising:
a first corner part arranged to be at least partially accommodated in the hollow space of a first frame part, and
a second corner part arranged to be at least partially accommodated in the hollow space of a second frame part.

15. Framework construction according to claim 14, wherein at least one of the frame parts comprises a threaded joint for attaching the corner element.

16. Method of re-manufacturing a framework construction according to claim 14, comprising the steps of:
inserting the first corner part into the hollow space of the first frame part; and
inserting the second corner part into the hollow space of the second frame part.
inserting the second corner part into the hollow space of the second frame part.
